(19) United States
(12) Patent Application Publication
(10) Pub. No.: US 2026/0330295 A1
(43) Pub. Date: Oct. 22, 2026

(54) AUTOMATIC ALIGNMENT OF MACHINE LEARNING MODEL SCORES FOR MODEL DEPLOYMENTS HAVING COMPATIBILITY WITH DOWNSTREAM COMPUTING SERVICES

(71) Applicant: PAYPAL, INC., San Jose, CA (US)

(72) Inventors: Yiming Bian, Shanghai (CN); Chang Cai, Shanghai (CN); Yingying Yu, Shanghai (CN)

(21) Appl. No.: 19/183,633

(22) Filed: Apr. 18, 2025

(51) Int. Cl. G06N 20/00

(52) U.S. Cl. CPC G06N 20/00

(57) ABSTRACT

There are provided systems and methods for automatic alignment of machine learning model scores for model deployments having compatibility with downstream computing services. A service provider, such as an electronic transaction processor for digital transactions, may utilize different machine learning and AI services, models, and the like for intelligent automation of certain tasks. These AI services may include AI models, which implement data variables, models, and/or rules. Models may be updated and/or exchanged, for example, to detect emerging fraud patterns. When models are updated, one model may be retired and another brought online for use with live traffic. To quick deploy the new model without retraining downstream models using an upstream model's output, a mapping file may be provided that maps the scores output by the new model to those that would be output by the folder model and that can be used with downstream services.

### TECHNICAL FIELD

The present application generally relates to machine learning (ML) scoring and other outputs of artificial intelligence (AI) models, and more particularly to aligning model outputs between different versions or updates of AI models for handling of data outputs by downstream computing services.

### BACKGROUND

Online service providers may offer various services to end users, merchants, and other entities. This may include providing electronic transaction processing data flows, services, and other computing resources. Further, the service provider may provide and/or facilitate the use of online merchant marketplaces and/or transaction processing between different entities. When providing these computing services, the service provider may utilize decision services, which may correspond to micro-computing services having machine learning (ML) or other artificial intelligence (AI)-based models, engines, and/or systems to process data requests and loads for different outputs (e.g., authentication, risk or fraud analysis, electronic transaction processing, etc.). In this regard, multiple microservices and other decision services depend on each other and operate together in a computing architecture, such as computing operations that may utilize upstream services to process data that is then provided to downstream services for further processing. These models may utilize hundreds of different data variables and assets from tens of thousands that may be available, and AI systems and ecosystems may include thousands of models operating on different rules and with other downstream models.

However, models may be retired and/or updated to new models or versions of models, and variables may also be removed or changed resulting in null values. This may adversely impact downstream model usages as the expected score, value, or other output may be null or have an incorrect benchmark and/or threshold. For example, a null value in a model or rule input may cause a significant score shift or incorrect decision, leading to live issues in decision-making by AI engines. Further, with many downstream models and rules, it is difficult to manually adjust for each model and rule. Thus, as more legacy variables and/or models require retirement or updating, current processes may not be able to correspondingly scale. Thus, a need exists for computing operations to test assets and changes made to the assets on a common platform asset against all the dependent services for commonality, such as followed by a new platform release, that addresses the problems with current systems.

### BRIEF DESCRIPTION OF THE DRAWINGS

FIG. 1 is a block diagram of a networked system suitable for implementing the processes described herein, according to an embodiment;

FIG. 2 is an exemplary diagram of data processing for artificial intelligence inferencing using an artificial intelligence model pipeline having automatically aligned scores between model updates and changes, according to an embodiment;

FIGS. 3A and 3B are diagrams showing machine learning model scores being aligned for model deployments of new or updated model, according to embodiments;

FIG. 4 is a flowchart of an exemplary process for automatic alignment of machine learning model scores for model deployments having compatibility with downstream computing services, according to an embodiment; and

FIG. 5 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods utilized for automatic alignment of machine learning model scores for model deployments having compatibility with downstream computing services. Systems suitable for practicing methods of the present disclosure are also provided.

A service provider, such as an online transaction processor, may provide digital products, computing services, and resources to users through different websites, native software applications (e.g., which may reside locally on a computing device), and/or online platforms. When utilizing the services of a particular service provider, the service provider may rely on artificial intelligence (AI) models and systems for decision services and microservices that implement rules and intelligent automations modeling human-like thought and decision-making processes (e.g., machine learning (ML), neural networks (NNs) or other AI-based process). These AI models and systems may be used for a wide array of functionalities including providing human-like inferences, predictions, and decisions on live and/or real-time data, which can be crucial for risk, fraud, anti-money laundering, and other harm reduction systems.

An online transaction processor may provide digital products and other computing services associated with electronic transaction processing, including account services, user authentication and verification, digital payments, risk analysis and compliance, and the like. A user may utilize online service providers, such as transaction processors, via their available online and networked platforms. For example, a user may make a payment to another user or otherwise transfer funds using the online platforms of the service providers. The user may also pay for one or more transactions using a digital wallet or other account with an online service provider or transaction processor (e.g., PayPal®). An account may be established by providing account details, such as a login, password (or other authentication credential, such as a biometric fingerprint, retinal scan, etc.), and other account creation details. The account creation details may include identification information to establish the account, such as personal information for a user, business or merchant information for an entity, or other types of identification information including a name, address, and/or other information. The account and/or digital wallet may be loaded with funds or funds may otherwise be added to the account or digital wallet. The application or website of the service provider, such as PayPal® or other online payment provider, may provide payments and the other transaction processing services via the account and/or digital wallet.

Once the account and/or digital wallet of the user is established, the user may utilize the account via one or more computing devices, such as a personal computer, tablet computer, mobile smart phone, or the like. The user may engage in one or more transactions with a recipient, such as a recipient account or digital wallet that may receive an amount of a payment. When engaging in these interactions, the service provider may provide AI models, systems, and decision services that may be used to process data requests and data loads and provide a decision or other output. Multiple AI models and/or systems may also be used together when providing computing services to users. For example, with some digital products, computing services, application, and the like, corresponding decision services may utilize multiple AI models for different data processing, such as an account balance, account login name, contact identifier, user input for the data request, profile or transaction history, or the like.

AI models may be utilized by and/or with the computing services to determine if, when, and how a particular service may be provided to users. For example, risk rules may be utilized with a risk AI engine for a decision service to determine if an indication of fraud is present in a digital transaction and payment, and therefore to determine whether to proceed with processing the transaction or decline the transaction (as well as additional operations, such as request further authentication and/or information for better risk analysis). Other fraud detection systems may utilize ML models based on decision trees, clustering algorithms and clustered records, and/or NNs and other deep learning algorithms. AI models and decision services may seek to automate repeatable decisions based on decision modeling capabilities so that computing services may execute and perform operations requested by a user's computing device more efficiently and accurately.

As a sub-category or field within AI models, rules, and engines, ML models may provide computer learning techniques and models to provide the inferencing, predicting, and/or decisioning from training on sets of data, without the explicit need for programming. That is ML models may be used by computers to provide outputs that are based on the computer's experience or knowledge of the training data and pattern recognition. However, as training data changes over time, for example, as the patterns, techniques, and tactics fraudster utilize to target and exploit companies and online service providers changes and evolves, ML models may be required to change, evolve, and be adapted to new knowledge and information. As such, ML models may be changed, updated, discarded, and newly created with different ML engines, platforms, and/or decision-making pipelines over time.

However, updating and/or exchanging models in current and evolving AI architectures and environments is complicated by the fact that outputs of machines using ML models does not provide easily translatable information for another ML model where multiple ML models may be involved in a final decision, inference, or other output. For example, generally, ML models may provide output scores on the input data. A first ML model may provide a score as an output, but without knowledge of the thresholds for different decisions (e.g., above score X is fraudulent while at or below score X is nonfraudulent, above score Y is high risk, between Y and a lower score Z is medium risk, and below score Z is low risk, etc.), other ML models may not properly assess the output of the first ML model. Conventionally, downstream ML models were updated to meet the changes to upstream models, which requires testing to ensure changes are fully adopted and properly implemented.

However, testing a computing platform with the latest changes for all ML models may not be practical or possible because of multiple team involvements and complexities of such models. For example, this type of testing may require creating a test build with a latest platform snapshot and/or computing code/build, setting up of a test environment, deployment, test execution of ML models with test data and/or snapshots or samples from real, live traffic, and sharing of the report. Additionally, availability, priority and geographical location of different teams, computing resources, and/or computing centers may add to the complexity of implementing score alignments across multiple different models and/or platforms. The changes made to a common or shared ML model may also occur frequently, making updating of all downstream ML models or ML models dependent on that model's output required to be updated with the same frequency.

In this regard, according to various embodiments described herein, the operations may instead be performed by mapping scores of a previous version of the model to a newer version of the model and utilizing a mapping file or in a data package for the mapping. This provides information enabling processors of other models to map outputs of the new model to outputs they would normally receive and understand according to previous alignment and training. As such, when the first model is in a model pipeline with two or more models downstream that may utilize the first model's output for further inferencing or other ML model outputs, the second or other subsequent models may each be calibrated to handle the first model's output based on the knowledge, understanding, and/or established scores and thresholds. In conventional ML model systems and pipelines, if the first model is updated or replaced with another model having different scores and/or scoring thresholds, the subsequent models may make incorrect decisions and/or have a significant score shift in the same data sets. Thus, when multiple models interact together, downstream models require scoring alignment for interdependency and to understand or properly process the upstream model's output. Shifts to a model's scoring or other output caused by model replacements, retirements, and/or updates may cause this alignment to be broken or incorrect, thereby leading to inaccurate AI outputs. This may be greatly reduced or even eliminated using the mapping process and components for scoring alignment between two ML models discussed herein.

Thus, the service provider may provide and implement a computing architecture that may function to analyze ML model deployment, including new model rollouts and/or model updates, as well as usage of variables for and/or to obtain different data that is processed by ML models, NN, rule-based engines, and the like in order to more efficiently and accurately align model scores and variable values or outputs during model updates, replacements, exchanges, or other changes to ML models used for the ML inferencing and output of the ML pipeline. A test service may be created using the latest version of a common platform and may process outputs of the new model and previous model, or another model that is being replaced, retired, exchanged, or updated. This test service may also provide similar functionalities to model variables, or particular data features or characteristics that may be determined, extracted from, or computed from/using the input data that the model is to act on (e.g., when a variable is updated to provide a similar but new characteristic of the data set), as well as when models change variable dependencies, such as by relying on a new source of data for a variable or change an ML feature and its corresponding variable(s).

When a change is performed to a model and/or model's variable, a service provider may provide an intelligent system for conducting score alignment on the new model or the model using the new variables with the retiring model or model using the previous variables. This allows the downstream models to switch their usage on legacy model scores or other outputs to the new model's scores and/or outputs automatically and with minimal impact on ML decisions by the ML pipeline. Upstream ML models may be adjusted such that downstream ML models may rely on outputs from new or adjusted models in place of legacy models. Downstream ML models may generally refer to ML models that take, as input at an input layer, an output from the upstream ML model that is to be updated, retired, or otherwise changed, but may also refer to any AI engine, AI system, processor, or service that utilizes the output of the upstream ML model. In this regard, AI engines may include rule-based engines, engines that implement algorithms or formulas, and the like. Conventionally, the new or adjusted models, when their scores may be different or unaligned with downstream models, may cause compatibility issues with the downstream ML models, AI engines, and/or decision services, causing improper inferencing and/or outputs by the risk pipeline or other AI decision pipeline.

As such, the system for model score correlation and alignment may improve the current risk ecosystem by resolving the issues with replacing legacy models with realigned new models that may have a different score output and/or threshold for certain decision-making, predictions, inferences, or the like. This allows for the downstream ML models, decision services, and the like to avoid a score shift/wrong decision in those downstream models/rules and keep live numbers stable. As such, there is not a need to manually adjust the downstream ML model/rule since the realigned new model will have same distribution as the legacy model, and the impact on the downstream model/rule is small. As manual efforts are greatly reduced by utilizing score alignment between the models, large volume and regular model retirement may be more easily scaled in an AI system. The systems and techniques for model alignment enable the new model's output distribution to be correlated and aligned to that of the legacy model, and downstream models/rules can directly switch the dependency to the realigned new model instead of adjusting parameters for each downstream model/rule.

The system may be implemented to query user activity data in a recent time period (e.g., the last X months). Columns in data tables for legacy model outputs and new model outputs may be retrieved and the records identified as actionable by the models may also be retrieved (e.g., those meeting or exceeding the models'risk threshold and therefore identified as risky, fraudulent, requiring analysis, causing alert generation, etc.). The system may identify those records correlated between the two models that are flagged by both models and identified as actionable and/or have the corresponding classification, label, inference, or prediction for that operation/operating point (e.g., a threshold or other score, value, or point in the data sets'outputs at which the trend or other analytics in the data set changes, such as when a data record is classified differently). Based on the queried data, the records are ranked by new model score and legacy model score, respectively, and the records may be distributed into buckets of equal size by their ranking, so that records with top X % (e.g., 1%) score are in the first bucket, records with top Y % (e.g., 10%) score are in the second bucket, and ongoing to the last bucket.

For each bucket, a score range of the new model and the legacy model are mapped between the new model scores and the legacy model scores. The result of this is a mapping table of the buckets, which identifies score ranges that fall into each bucket. Buckets and/or percentile selections for the buckets may be made based on operation points in each of the ML model's outputs, and the operation points may correspond to different percentages of the population on which an action is taken based on the scores falling into that bucket. Each bucket may include a distribution of the scores in the score range of the bucket to allow for more accurate conversion of scores in buckets, which may be represented as a graph or other representation of the scores in the score range of the bucket, a function representing the score distribution, and/or the like. The distribution may be different for each bucket and specifically represent how the scores in that bucket were distributed from data set used for mapping the new model's scores to the legacy model's scores.

In order to convert a new model's score into a legacy model's distribution, the system may first identify the bucket in the new model's distribution and leverage the mapping table to find the score range in the legacy model's distribution. The determination of the distribution after mapping enables determination of an offset in the new model bucket's score range, which allows the system to determine an exact score value in the legacy model's distribution for the new model's score. The new model may then be repackaged with the mapping table so that the realigned new model output may be realigned and correlated to the same distribution with the legacy model. The system may then enable a hot swap of the legacy model with the realigned new model in a live ecosystem, such that there is little impact on downstream models/rules because the new model's output has been realigned to the outputs of the legacy model. During the inference stage when providing an output from the new model, the mapping file may be provided, or the ML model's data package may contain information that may be used, to convert new model scores to those of the legacy or previous model that was brought offline or replaced. This allows for the systems that are dependent on that particular scoring threshold, design, or paradigm, to continue running with little to no changes. Thereafter, the realigned, converted, or mapped score may be input to the downstream model for processing using the previous score alignment and/or model training of that downstream model.

As such, an ML pipeline utilizing one or more downstream ML models, AI engines, or the like that are dependent on or process the output of an upstream model may not be required to be individually updated and realigned to the scores of the changed, retired, or updated model upstream, and instead may process those outputs directly with minimal to no system infrastructure changes. This allows for faster implementation of new ML models, adapting to changes in emerging data patterns and behaviors. As such, ML models may stay relevant and current to properly handle the newest live and real-time data and may not be required to be constantly retrained and/or taken offline for further configurations. Additionally, by reducing or eliminating the need for testing of ML models when retrained or adapted to different scoring thresholds and the like for ML model outputs, system resources demand and usage may be considerably reduced, and a more efficient ML system may be provided. This may all be done without manually coding and creating new ML models for score alignment, thereby significantly reducing pressures on internal systems of new ML model updates and releases for changing ML model infrastructure.

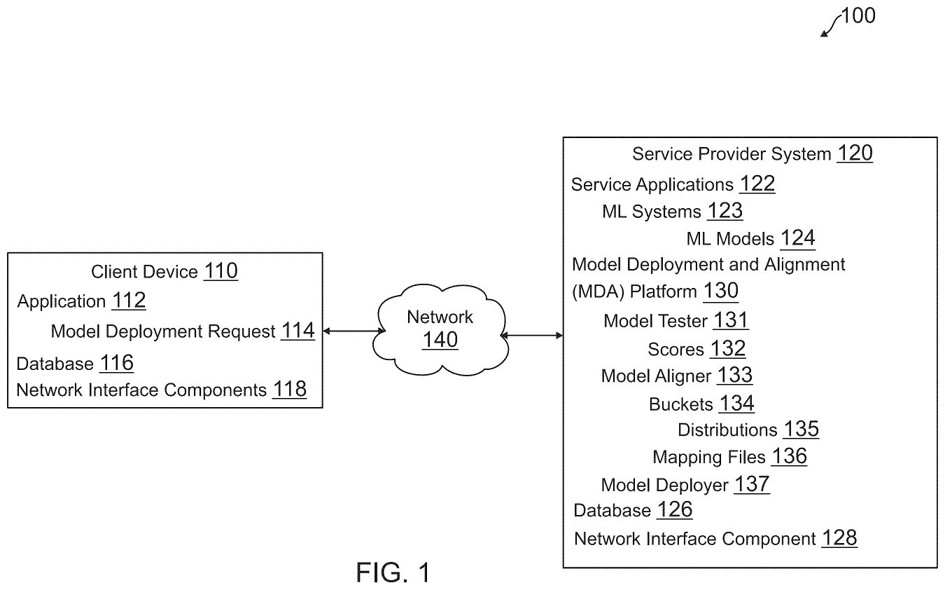

FIG. 1 is a block diagram of a networked system 100 suitable for implementing the processes described herein, according to an embodiment. As shown, system 100 may comprise or implement a plurality of devices, servers, and/or software components that operate to perform various methodologies in accordance with the described embodiments. Exemplary devices and servers may include device, stand-alone, and enterprise-class servers, operating an OS such as a MICROSOFT® OS, a UNIX® OS, a LINUX® OS, or another suitable device and/or server-based OS. It can be appreciated that the devices and/or servers illustrated in FIG. 1 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entity.

System 100 includes a client device 110 and a service provider system 120 in communication over a network 140. Service provider system 120 may be utilized by customers and other individual users, including those associated with entities such as businesses and merchants, to access computing services or resources provided by service provider system 120, where service provider system 120 may provide various data, operations, and other functions to client device 110 via network 140. The computing services may utilize AI systems and services for decision-making during data processing. In this regard, the users may access a website, application, or other platform that provides computing services including the AI services. Client device 110 may be used by an internal user, employee, or the like of service provider system 120, such as a data scientist or other user involved in AI modeling including training, testing, and deploying ML models, to update a model, retire a model, add a model, or otherwise change models with the AI system. As such, service provider system 120 may provide an internal tool, platform, and service where model updates may be performed faster, more efficiently, and with better accuracy using a score alignment and mapping of scores between models.

Client device 110 and service provider system 120 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 140.

Client device 110 may be implemented as a communication device that may utilize appropriate hardware and software configured for wired and/or wireless communication with service provider system 120. For example, in one embodiment, client device 110 may be implemented as a personal computer (PC), a smart phone, laptop/tablet computer, wristwatch with appropriate computer hardware resources, eyeglasses with appropriate computer hardware (e.g., GOOGLE GLASS® and/or other headsets including metaverse configured headsets), other type of wearable computing device, implantable communication devices, and/or other types of computing devices capable of transmitting and/or receiving data. Although only one device is shown, a plurality of devices may function similarly and/or be connected to provide the functionalities described herein.

Client device 110 of FIG. 1 contains an application 112, a database 116, and a network interface component 118. Application 112 may correspond to executable processes, procedures, and/or applications with associated hardware. In other embodiments, client device 110 may include additional or different modules having specialized hardware and/or software as required.

Application 112 may correspond to one or more processes to execute software modules and associated components of client device 110 to provide features, services, and other operations for a user over network 140 including the Internet, as well as smaller private networks utilized by companies and businesses. As such, application 112 may be used to perform model changes to an AI system of service provider system 120, which may include providing and/or determining mappings for score alignments usable by other AI models and services of service provider system 120 to adjust scores between two or more AI models. In this regard, application 112 may correspond to specialized software utilized by a user of client device 110 that may be used to access a website or application (e.g., mobile application, rich Internet application, or resident software application) that may display one or more user interfaces that allow for interaction with the computing services of service provider system 120 including updating and/or configuring one or more applications, platforms, websites, or other systems that utilize AI models and components.

In this regard, application 112 may correspond to specialized software utilized by client device 110 that may be used to access a website and interfaces (e.g., via a browser application, mobile application, rich Internet application, or resident software application) that may display one or more user interfaces to interact with and/or maintain, update, and/or configure the computing services of service provider system 120. As such, in various embodiments, application 112 may correspond to a general browser application configured to retrieve, present, and communicate information over the Internet (e.g., utilize resources on the World Wide Web) or a private network. However, in other embodiments, application 112 may include a native software application provided by and/or used with service provider system 120 to perform AI model deployment and mapping configurations for score alignment.

Application 112 may correspond to and/or be utilized during the course of AI model lifecycle maintenance for different computing services provided by service provider system 120. When utilizing application 112 with service provider system 120, application 112 may provide and/or request processing of a model deployment request 114. Model deployment request 114 may correspond to updating an AI service, such by deploying of an AI model or other model asset with a decision service and/or for availability by AI models of different decision services, or other changes to one or more AI systems, components, or models. For example, AI models may be brought offline or retired, which may affect a common model in an AI pipeline and therefore downstream models relying on or utilizing the model's output may receive a null value or static value, affecting proper AI outputs such as inferences or decisions reliant on the retired model's original score. Model deployment request 114 may have a corresponding model package, model artifacts or other model assets, a mapping for score alignment between the previous model's scores and/or the new model's scores (e.g., the model being deployed, if any), and/or a data set usable for generating the mapping or other alignment between model scores. As such, the mapping may be pre-generated or may be determined by service provider system 120, as discussed herein. Furthermore, while score outputs are discussed herein, such as in the context of ML models that score input data based on training and features of that data, it is understood it is understood that other types of outputs, such as classifications, may also be aligned as discussed herein, as well as other types of AI or computing models.

Application 112 may be used with the AI systems and services of service provider system 120, which may provide processing of model deployment request 114 to perform a model update of an AI system. Because the AI system may have a pipeline or framework of AI models interacting together, such as an ML pipeline for risk and/or fraud detection or other risk analysis and decisioning, other downstream models and/or components may rely on the output of the model that is being retired, updated, or otherwise changed. Model deployment request 114 may be provided to service provider system 120 for processing and determination of an alignment between the old or retired model's scores and the new or current model's scores that are to be output from the AI model after processing of model deployment request 114 and deployment.

Client device 110 may further include or be associated with database 116, which may store various applications and data and be utilized during execution of various modules of client device 110. Databases 116 may correspond to different types of data storage and components including cloud computing storage nodes, remote data stores and database systems, distributed database systems over network 140, and the like used to store various applications and data. Database 116 may include, for example, identifiers such as operating system registry entries, cookies associated with application 112 and/or the other applications, identifiers associated with hardware of client device 110, or other appropriate identifiers, such as identifiers used for payment/user/device authentication or identification, which may be communicated as identifying the user/client device 110 to service provider system 120. Moreover, database 116 may include data used for model deployment request 114, such as a model and/or model file to be deployed, model assets or artifacts, model training and/or test data, and/or score alignment data including a pre-generated mapping file or other mapping data and/or a data set usable for mapping model scores from a model to be retired or updated and the model to be used or deployed into production and use.

Client device 110 includes at least one network interface component 118 adapted to communicate with service provider system 120 and/or other devices and servers over network 140. In various embodiments, network interface component 118 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Service provider system 120 may be maintained, for example, by an online service provider, which may provide computing services that utilize AI systems and services for intelligent and automated decision-making in a production computing environment, such as when providing digital products and computing services to different users based on data processing requests. In this regard, service provider system 120 includes one or more processing applications which may be configured to interact with client device 110 for AI system maintenance, updating, model deployment, and other AI system management. Service provider system 120 may also interact with multiple different end users, customers, and/or entities via other clients and client devices, which may include providing the products and services to individual users and/or entities (e.g., businesses, merchants, etc.). For example, service provider system 120 may deploy AI models including ML models and/or ML model pipelines with intelligent decision services that may automatically align scores between models that have been and/or are deployed using score mapping or other mapping of outputs between the models. In one example, service provider system 120 may correspond to an online transaction processor, and may be provided by PAYPAL®, Inc. of San Jose, CA, USA. However, in other embodiments, service provider system 120 may be maintained by or include another type of service provider.

Service provider system 120 of FIG. 1 includes service applications 122, a model deployment and alignment (MDA) platform 130, a database 126, and a network interface component 128. MDA platform 130 and service applications 122 may correspond to executable processes, procedures, and/or applications with associated hardware. In other embodiments, service provider system 120 may include additional or different modules having specialized hardware and/or software as required.

Service applications 122 may correspond to one or more processes to execute modules and associated specialized hardware of service provider system 120 to process a transaction or provide another service to customers, merchants, and/or other end users and entities of service provider system 120. In this regard, service applications 122 may correspond to specialized hardware and/or software used by service provider system 120 to providing computing services to users, which may include electronic transaction processing and/or other computing services using accounts provided by service provider system 120. Service applications 122 may be used by a user to establish an account and/or digital wallet, which may be accessible through one or more user interfaces, as well as view data and otherwise interact with the computing services of service provider system 120.

Service applications 122 may correspond to the different digital products and/or computing services of service provider system 120 and/or offered by a corresponding service provider to users and entities (e.g., business and merchants). As such, the products and service may be accessible and/or utilized through service applications 122, as well as external interfaces including websites, native application data and interfaces, and/or other accessible digital platforms. Where service provider system 120 corresponds to an online transaction processor, service applications 122 may include a transaction processing application corresponding to electronic transaction processing, payment accounts, payment messaging, and the like that may utilize, connect to, and/or execute an ML system 123 having ML models 124 including an ML model that may be updated, retired, and/or replaced by a new, retrained, or reconfigured ML model. ML models 124 may be used for automated and intelligent decision-making for requests and data processing operations associated with the digital products and computing services provided by service applications 122. In this regard, ML models 124 may, when service provider system 120 corresponds to an online transaction processor, provide intelligent decision-making, inferencing, and/or predictions, such as those associated with risk and/or fraud, compliance, credit or underwriting, authentication and/or identity verification, and the like. In some embodiments, service applications 122 may include or instead correspond to computing services for social networking, media posting or sharing, microblogging, data browsing and searching, online shopping, and other services that utilize ML models 124 of ML system 123.

Service applications 122 may utilize ML models 124 to provide intelligent decision-making and other outputs for computing operations. Account services, account setup, authentication, electronic transaction processing, and other computing services of service applications 122 may utilize ML models 124, such as for authentication, electronic transaction processing, risk analysis, fraud detection, and the other decision-making and data processing required by the aforementioned computing services. ML models 124 in ML system 123 may be incorporated in a pipeline or other framework where models utilize and/or are reliant on the outputs of other models. For example, with a pipeline or lineage that includes a set of ML models 124, initial variables may be responsible for and/or identify the data for the corresponding input ML feature to be processed. This may be handled by one or more upstream models, which provide an output, and one or more downstream models may process this output, as well as one or more other ML outputs, to provide an ML output to a set of rules or a rule engine.

In this regard, a variable, the upstream models, and/or the downstream models of ML models 124 may all provide scores or other values, and when updated, replaced, retired, or otherwise changed, may differ in their score outputs. As such, when model deployment request 114 updates ML models 124, a corresponding alignment of the new model's score to the old model's score may be required. In other embodiments, different types of AI models may also be operated on in a similar manner discussed herein for score alignment, and as such ML system 123 may also utilize and/or include other types of AI models, engines, and/or decision systems require a score or value alignment including the variables, AI rule engines, NNs and/or other deep learning models, and the like.

To perform score alignment for model deployment request 114 and/or enable ML model processing using thresholds and other criteria for decision-making with the past ML model, service provider system 120 may utilize MDA platform 130 to test two or more models for model scoring and determine a score alignment between those models scores. For example, with two of ML models 124, where a first ML model is to be replaced in an ML decision pipeline with a second ML model, score and other model alignments may be used to correlate the outputs of the second ML model when in use and in production to the first ML model that has been retired, replaced by the second ML model, and/or brought offline. This allows for downstream models, rules, engines, and/or other services to utilize their existing training and/or configurations to process the first ML model's scores and/or other outputs based on corresponding thresholds, operation points, score classifications, and the like.

MDA platform 130 may correspond to one or more processes to execute modules and associated specialized hardware of service provider system 120 to update, test, and/or provide ML models 124 with model alignment mappings and/or other score or model alignment data that may map, convert, and/or transform between two or more models scores. In this regard, MDA platform 130 may correspond to specialized hardware and/or software used by different users, clients, and/or endpoints, such as client device 110, to determine these score alignments and mappings by testing each model for model scores and then aligning those scores between the models for the same data record or other selected data to be processed. MDA platform 130 includes a model tester 131 configured to execute one or more of ML models 124 using a test data set and determine scores 132 or other outputs for the tested data set and model(s). Scores 132 may correspond to ML outputs based on a test data set or other data set at stake for score alignment and conversions. Scores 132 may be determined by model tester 131 providing input ML feature data for the corresponding one of ML models 124 and receive output data in the form of a score, value, classification, or other range of output data that requires mapping and/or correlation between different models.

As such, to provide input ML feature data to a model and determine scores 132, model tester 131 may correspond to an ML model execution framework including operations for data preprocessing, hyperparameter selection, model and/or variable adjustments, and/or conversion or translation of ML model outputs to a final output that may be utilized by other downstream models, rules, services, and the like. When scores 132 are determined, scores 132 may be annotated, labeled, and/or correlated with the ML model of ML models 124 that generated the score, as well as the data records or other specific data from the data set that was processed by the ML model to generate the score, allowing for mapping between different model outputs.

Scores 132 may be processed by a model aligner 133 that may perform score alignments and other alignments, transformation, conversions, or translations of one model's output to two or more other models'outputs. While directly correlating one score with another provides a one-to-one correspondence and conversion between scores, to account for a range of scores, model aligner 133 may utilize buckets 134, which correspond to data buckets of two or more sets of scores 132, to group smaller sets of scores 132 for each ML model, the new and legacy ML model. Buckets 134 may each have a set of scores 132 that account for the scores that fall into a range between two operation points, a higher operation point (or the maximum score or top of the scoring range) and the next lower operation point at which action may be taken. Each of buckets 134 may correspond to one of the two models that are to be aligned and each of buckets 134 has a corresponding matching bucket (e.g., having the same upper/lower operation point or score range) for the other one of the two models to be aligned). As such, for a specific operation point and score range between that operation point and the next, two of buckets 134 may each correspond to a data set of scores 134, a first set of scores 134 for the new model and a second set of scores 134 for the legacy model.

As such, buckets 134 may correspond to a set of scores 132 falling in a particular sub-range of a larger range for all model scores and may be used to correlate those scores from one model's output to the score for the same one of buckets 134 for another model. Buckets 134 may be selected based on a desired operation point or percentage of the population of data records or other data points in the data set being tested by model tester 131. For example, with risk models, there may be a low total amount of fraud or risky activity in a large transaction data set, and thus, risk actions taken based on outputs by a risk ML model of ML models 124 may only be taken on a low percentage of the population. In this example, when testing the risk ML model for replacement of an older or retiring risk ML model, an operation point of 0.3% (or other threshold) for a risk action may be selected, which indicates that for 0.3% of the population a risk action is to be taken. As such, 0.3% of the data records for the test data set may be flagged for the risk action, and a corresponding threshold may be set. This may continue for progressively different operation points until buckets 134 corresponds to a set of data buckets each containing different subsets of scores 132 falling into a sub-range of the total overall range.

Each one of buckets 134 therefore corresponds to a range having an upper score cutoff and a lower score cutoff, and for two ML models being mapped, each bucket may identify an operation point for the score range in that bucket and those upper and lower score cutoffs. Further, each of buckets 134 includes distributions 135 of scores 132. Distributions 135 may be used to ensure that, if a significant number of scores all fall at one end or in a particular grouping within the sub-range for a corresponding one of buckets 134, not all values within that sub-range are given equal weight when mapping and/or converting scores 132 between different ones of ML models 124. Thus, distributions 135 may provide a curve or other function representing how those of scores 132 are distributed in each of buckets 134. Distributions 135 may be transformed between two of ML models 124 when performing the score alignment and mapping, and as such, may provide for determination of the new model's scores in the distribution and value as the old model's scores.

Once model aligner 133 has determined and filled buckets 134 from scores 132 and has transformed distributions 135 for each of buckets 134 between the models, mapping files 136 may be generated for the alignment between the two models. Mapping files 136 may provide a mapping of these scores by providing buckets 134 for the score range with distributions 135 transformed between the models, allowing for mapping and/or conversion of model scores. In some embodiments, mapping files 136 may include an executable and/or data from a conversion program, application, or the like that enable other applications, systems and/or model processors to perform the conversion, or may provide the data necessary for the application or processor to utilize for the score mapping and conversion. Mapping files 136 may be utilized with a model deployer 137 to deploy the corresponding one of ML models 124 for use in a production system or computing environment, such as with service applications 122. Model deployer 137 may generate or package the ML model, model artifacts or other model data, training data, algorithm, and the like with a corresponding one of mapping files 136 for the ML model to be executed by a model processor and/or engine, as well as for that model processor or engine to convert or map between model scores for proper downstream model, rule, or service usage of packaged model's outputs.

As discussed herein, ML system 123 includes ML models 124, and service provider system 120 may include other AI models, such as ML or neural network (NN) models, rule sets and rule engines, generative AIs, and the like. AI models may generally correspond to any artificial intelligence that performs decision-making, and includes subcategories for machine intelligence including ML models and NNs that provide intelligent decision-making using algorithmic relationships and pattern recognition in data sets. Generally, NN models may include deep learning models, and may correspond to a subset of ML models that attempt to mimic human thinking by utilizing an assortment of different algorithms to model data through different sets, graphs, or connection pathways of neurons. Neurons include nodes of data representations computed using NN and deep learning algorithms, which have the nodes then interconnected with different nodes based on their representations and relationships. ML models may similarly utilize one or more of these mathematical algorithms and/or models and similarly generate layers of connected nodes in a similar manner to neurons of NN models.

When building ML models 124, training data may be used to generate one or more classifiers and provide recommendations, predictions, or other outputs based on those classifications and an ML model. ML models 124 may include one or more layers, including an input layer, a hidden layer, and an output layer having one or more nodes, however, different layers may also be utilized. For example, as many hidden layers as necessary or appropriate may be utilized. Each node within a layer is connected to a node within an adjacent layer, where a set of input values may be used to generate one or more output scores or classifications. Within the input layer, each node may correspond to a distinct attribute or input data type that is used to train ML models 124.

Thereafter, the hidden layer may be trained with these attributes and corresponding weights using an ML algorithm, computation, and/or technique. For example, each of the nodes in the hidden layer generates a representation, which may include a mathematical computation (or algorithm) that produces a value based on the input values of the input nodes. The ML algorithm selected may assign different weights to each of the data values received from the input nodes. The hidden layer nodes may include different algorithms and/or different weights assigned to the input data and may therefore produce a different value based on the input values. The values generated by the hidden layer nodes may be used by the output layer node to produce one or more output values for ML models 124. Thus, when ML models 124 are used to perform a predictive analysis and output, the input may provide a corresponding output based on the classifications trained for ML models 124. Those outputs may correspond to values, such as scores 132, for different data records in a data set used for training, testing, and/or model score alignment of ML models 124.

ML models 124 may be trained by using training data associated with the corresponding task. By providing training data to train ML models 124, the nodes in the hidden layer may be trained (adjusted) such that an optimal output (e.g., a classification) is produced in the output layer based on the training data. By continuously providing different sets of training data (and with NNs, penalizing NNs of ML models 124 when the output of the network is incorrect), ML models 124 (and specifically, the representations of the nodes in the hidden layer) may be trained (adjusted) to improve its performance in data classification. Adjusting ML models 124 may include adjusting the weights associated with each node in the hidden layer. Thus, the training data may be used as input/output data sets that allow for ML models 124 to make classifications based on input attributes. The output classifications for one or more of ML models 124 may be classifications predictions, or suggestions associated with unifying code changes and/or creating or changing tests for asset validations.

In further embodiments, model tester 131 and/or model aligner 133 may be utilized when MDA platform 130 requires testing and aligning of model variables, rules, or other components of an AI system or automation that utilizes scores and other computations from data for decisions, classifications, and the like. For example, a data variable used by ML models 124 may correspond to a particular characteristic or property of a data set, such as a column in a data table, that can be measured or determined from data that can be gathered by the components of service provider system 120. A variable may therefore be measured and recorded to a data table from different sources, which may differ in their scoring, measuring, or valuing of the underlying data. As such, variables may require alignment so that ML models 124 and other models, applications, processors, engines, and the like that utilize the variables during computations, processing, and decision-making may properly process the input data under the correct assumptions, scoring thresholds, and the like. Rules may operate on data in a similar manner, and therefore, a change to a rule and/or component of a rule may cause a scoring mismatch between rule outputs on the same input data.

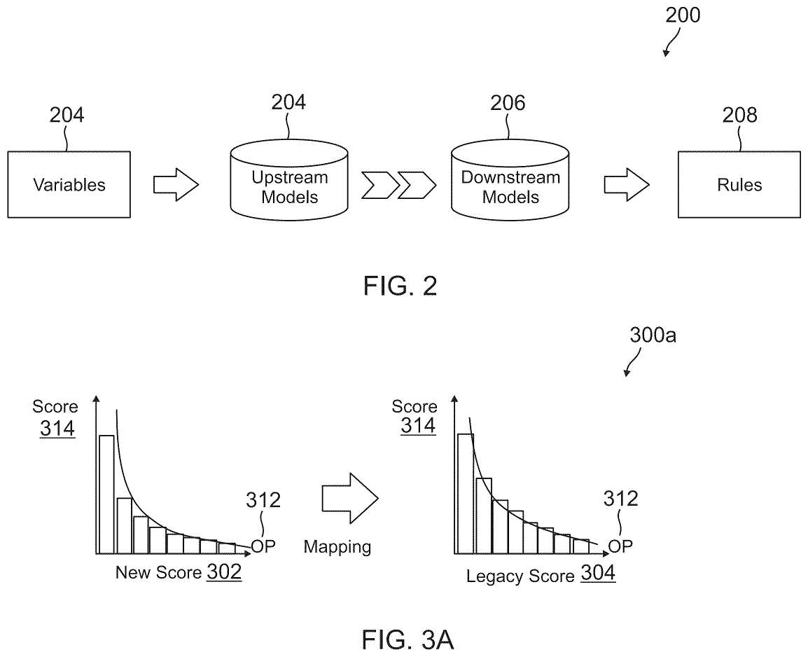

The operations of MDA platform 130 to perform score, value, and/or model alignments between two or more ML models, variables, and/or rules are discussed in further detail below with regard to FIGS. 2-4.

In various embodiments, service applications 122 may further provide additional features for service provider system 120. For example, service applications 122 may include security applications for implementing server-side security features, programmatic client applications for interfacing with appropriate application programming interfaces (APIs) over network 140, or other types of applications. Service applications 122 may contain software programs, executable by a processor, including a graphical user interface (GUI), configured to provide an interface to the user when accessing service provider system 120 via client device 110 as an internal user, employee, or administrator, as well as to customers and other end users, including end users acting in representative capacity for an entity, such as a merchant or business. Users may interact with the GUI to view and communicate information more easily. In various embodiments, service applications 122 may include additional connection and/or communication applications, which may be utilized to communicate information over network 140.

Additionally, service provider system 120 includes and/or is associated with database 126. Database 126 may store various identifiers associated with client device 110. Database 126 may also store account data, including payment instruments and authentication credentials, as well as transaction processing histories and data for processed transactions. Database 126 may store financial information and tokenization data. Database 126 may further store data necessary for execution of ML models 124, such as model assets, artifacts, training data, and the like used by ML system 123 for modeling, inferencing, aligning scores, and other tasks, as discussed herein. Although database 126 is shown as residing on service provider system 120 as a database, in other embodiments, other types of data storage and components may be used including cloud computing storage nodes, remote data stores and database systems, distributed database systems of a computing system associated with service provider system 120 and/or available over network 140, and the like.

In various embodiments, service provider system 120 includes at least one network interface component 128 adapted to communicate client device 110 and/or other devices and servers over network 140. In various embodiments, network interface component 128 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 140 may be implemented as a single network or a combination of multiple networks. For example, in various embodiments, network 140 may include the Internet or one or more intranets, landline networks, wireless networks, and/or other appropriate types of networks. Thus, network 140 may correspond to small scale communication networks, such as a private or local area network, or a larger scale network, such as a wide area network or the Internet, accessible by the various components of system 100.

FIG. 2 is an exemplary diagram 200 showing components and operations of data processing for artificial intelligence inferencing using an artificial intelligence model pipeline having automatically aligned scores between model updates and changes, according to an embodiment. Diagram 200 displays an exemplary lineage of AI data processing for AI outputs, such as intelligent inferences, decisions, and/or predictions on input data and may be performed by ML system 123 of service provider system 120, discussed in reference to system 100 of FIG. 1. In this regard, the operations may be executed to intelligently and procedurally map and/or generate mappings of scores or other outputs between two or more AI components, such as ML models 124 of ML system 123 in system 100.

In diagram 200, the lineage of AI components may be executed and/or used for a particular AI task, output, data processing, or the like. Diagram 200 includes multiple ML models, as well as model variables (e.g., data corresponding to input ML features to be processed) and rules 208 (e.g., one or more AI rules or rule sets that may be used by the ML pipeline in diagram 200 to generate decisions or classifications). In this regard, diagram 200 may correspond to an ML pipeline, which may be used to calibrate ML models to a scoring paradigm, value set, or range of values, or otherwise align scores between two or more models so that accurate decision-making and classifications by ML models, or other AI components, may be made based on established thresholds and conditions. These thresholds or other score conditions may be used to determine one or more actions to take with regard to a user, account, transaction, event, or the like when a score meets, does not meet, or exceeds a score threshold. For example, two or more actions may be set for one or more thresholds, such as an X, Y, and Z value threshold for a score range. When below X, no action may be taken, and the data record may be identified as low risk or non-fraudulent. Between X and a higher threshold (e.g., higher score, which indicates higher risk) and Y, a data record may be identified as medium risk and an action may be taken to verify a user identity and/or require multi-factor authentication. When the scores exceed an even higher threshold Z, the data record may be classified as high-risk, and the action taken may include blocking the activity or initiating a fraud investigation and account takeover and recovery process to minimize fraud and harm.

In this regard, the ML pipeline or other lineage of AI components used for a particular AI task, service, or system may be interconnected so that, based on the scores or other outputs and data from one component of the pipeline that values, rates, or categorizes data records in a data set (e.g., transactions in a transaction data set for risk and fraud), another component of the pipeline may act on that output, as well as other data for the data record and/or from other outputs, to reach a final score or decision on the data record. Diagram 200 includes variables 202 that provide input data to ML models or other AI components, such as ML models 124 discussed in reference to system 100 of FIG. 1. In some embodiments, variables 202 may correspond to a measurable and/or quantifiable data characteristic, trait, or property for a data set, such as a column in a data table, that may be determined through observation and/or calculation. Variables 202 may correspond to and/or be utilized to fill or determine model features of ML models 124. Model features may correspond to those features of a data set that are processed by a model, and variables 202 from a data set may correspond directly to a feature or be used to compute a feature. Variables 202 may therefore provide a data value, which, in some embodiments, may also need alignment where measurement, observation, and/or calculation of that value is changed or updated, or the variable is deleted or retired.

Variables 202 may provide data to upstream models 204, which may determine a score or other output to downstream models 206. Upstream models 204 and downstream models 206 may correspond to ML models 124, such as decision trees, trained clusters and clustering models, NNs and deep learning models, and the like. However, upstream models 204 and/or downstream models 206 do not necessarily require ML for scoring of data and/or providing an output or processing an input that may need an alignment. For example, rules and rule sets of an AI engine may also require alignment for processing inputs and/or providing outputs converted or transformed to another scoring range and distribution. Upstream models 204 may correspond to one or more ML models that process one or more of variables 202 based on their corresponding training, and provide an output, such as a score. As such, the ML pipeline in diagram 200 may move from variables 202 to upstream models 204 that process variables 202 and provide an output to downstream models 206.

Downstream models 206 may correspond to other ML models that may be trained to take, as input, a score or other output from one of upstream models 204, as well as other input features including other model scores from other ones of upstream models 204, one or more of variables 202, and/or other available input data for ML features, and process that score for determination of a different score or other output to rules 208. Although different due to their difference with ML model calculation from training, the scores are related to the ML decisioning or inferencing by the ML pipeline. As such, upstream models 204 and downstream models 206 may both provide scores or other values as outputs and may also process scores or other values as inputs from variables 202 and/or upstream models 204.

Rules 208 may correspond to coded rules that result in a categorization, action, or determination being made based on outputs from one or more of the components of the ML pipeline shown in diagram 200. For example, a rule may require that a transaction be classified as fraudulent if a score from downstream models 206 is 500 or over. The rule may also require that the account undergo an account review and/or account takeover procedure to limit or reduce harm and risk. As such, rules may also designate actions to be taken based on the scores. In this regard, when one of the components in diagram 200 is brought offline, is updated, or is changed for a new model, and a score is changed, there may be an effect on the entire pipeline, particularly for the models and/or rules dependent on the changing model, rule, or variable.

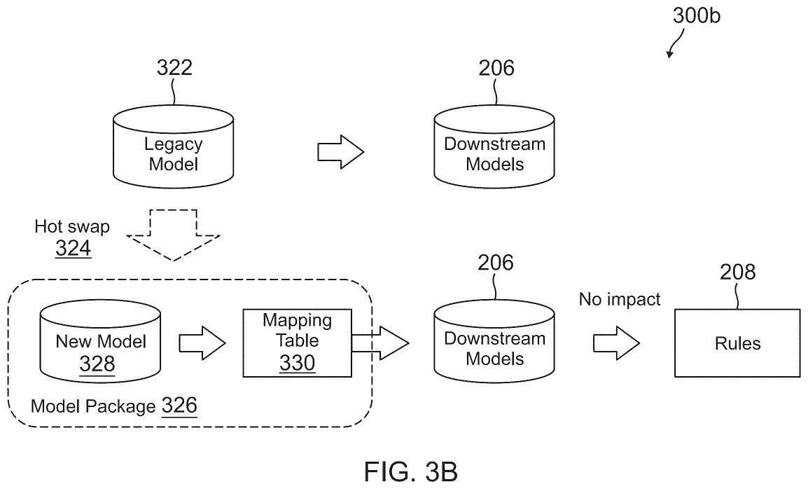

Thus, the service provider may generate mapping files as discussed herein, which may map a new model's, rule's, or variable's score ranges and/or outputs to those of an old model, rule, or variable that is being retired, updated, or brought offline. In this regard, the mapping may be generated, as discussed in further detail below with regard to FIGS. 3A and 3B, using test data or a data set usable to determine scores by each model for the same data records or other individual datum in the set. The scores may then be bucketed by operation point, such as percentages of the population of data records (e.g., of users, devices, accounts, etc.) that would be acted to or have an action taken against based on their score. For example, with a 0.3% operation point, 0.3% of scores may be flagged, and their record similarly flagged, by meeting or exceeding a corresponding threshold for that 0.3%. However, based on the model scoring for the old model being retired, the scores in that bucket may be 500-600, while with the new model, may be 750-800. The buckets may be used with distributions for score alignment between the models, and may freely allow for scores to be translated or converted between the models.

Thus, as the ML pipeline in diagram 200 is updated and models, variables, and/or rules are switched in and/or out, replaced, retired, and/or newly added, scoring ranges and threshold may change. These alignments may ensure proper model function without retraining models and reconfiguring additional model assets, artifacts, or other model components. Once a mapping is determined, a model package may be deployed having the model or model assets (e.g., artifacts, training data, node weights/activation functions, etc.) with the mapping file or other mapping and mapping data for score alignment. This may mean that upstream models 204 include models deployed as data packages, files, or the like with a mapping file. Downstream models 206 may utilize the mappings and/or mapping file to compute scores for the old model's ranges and thresholds, but based on the new model's actual outputs, thereby retaining the benefit of the model update or replacement. For example, the new model may be trained on new fraud patterns, and therefore may be capable of scoring and inferring fraud with such patterns. This benefit may be conferred to the previous downstream and/or dependent models, services, rules, and the like, which operate on the fraud likelihood determined from the upstream model.

FIGS. 3A and 3B are diagrams 300a and 300b showing machine learning model scores being aligned for model deployments of new or updated models, according to embodiments. Diagram 300a shows a representation of exemplary score distributions in buckets of scores determined for score alignment between two ML models, which may be processed to provide accurate score alignments between an output score by one ML model or another AI component and a target score by another ML model or AI component. Processes for determining the buckets and distributions in diagram 300a may be performed by MDA platform 130 of service provider system 120, discussed in reference to system 100 of FIG. 1. Using score alignments that consider these score distributions, an ML engine or system in diagram 300b may be updated to utilize a new ML model, such as by performing a hot swap of a legacy model with the new model, based on score conversions when aligning scores between such models determined using a mapping file and/or table from mapped model scores, operation points, and distributions.

When an AI service requires a change to an AI model, rule, component, or variable that performs scoring or other AI outputs, MDA platform 130 may be invoked to test the models to be changed, such as an old ML model that is to be replaced by a new ML model, and effectuate a score alignment that allows for scores determined by the new ML model that have values in a range and distributions of the new ML model to instead be converted to a score from the old ML model, for example, based on the values, range, and/or distributions of scores from the old ML model on the same data set. As such, a service provider may determine a mapping and generate a mapping file of the alignment between the two ML models'output scores, such as by providing a mapping to convert between values in one range and corresponding distributions to another range and corresponding distributions. The mapping may provide a score conversion process by which a score may be converted from one ML model's outputs to another ML model's outputs, as described below.

In various embodiments, an exemplary mapping file may include the following information, which is provided as an example and therefore may vary in data, values, and the like that may be necessary to convert scores between two or more different ML models. In the exemplary mapping file, such as a comma-separated values (CSV) file, there may be 5 column and 10000 rows, each row standing for one operation point. The 5 columns may be designated for each OP (operation point, ranked by score from top to bottom, OP 1% stands for a population with a score in top 1%;), score_x_min (lower boundary of the new model score within this OP), score_x_max (upper boundary of the new model score within this OP), score_y_min (lower boundary of the old model score within this OP), and score_y_max (upper boundary of the old model score within this OP). The mapping file may be patched into new model's file, and this file may then be transformed into a list of commands for each OP. An example of a row with value may be as follows: OP:1%, score_x_min:500, score_x_max: 600, score_y_min: 600, score_y_max:800. This row may then be translated into the following command: If score_value between 500 and 600, then final_score_value should be (score_value−500)/(600−500)*(800−600)+600. As these commands are compiled into the new model file, the new model's scores may automatically be processed and converted/mapped by these commands for every computation. Therefore, the new model's scores can be aligned and converted to a desired score distribution using the commands determined from the mapping file.

In diagram 300a of FIG. 3A, a new score bucket graph 302 is compared to a legacy score bucket graph 304, where the score values or ranges for scores in each bucket are shown based on representing the operation point values along the x-axis by operation points 312 against the model score values along the y-axis by scores 314. Operation points 312 may include a range of values, or a set of scores or other model outputs, for a particular category or type of operation point corresponding to the scores and their underlying data records. In this regard, legacy score bucket graph 302 includes a first set of data buckets for the data buckets of model scores or other model outputs from the legacy ML model. As the new ML model is run and scores or other model outputs are determined for the same data set, new score bucket graph 302 may be generated that includes a second set of data buckets of those scores for alignment to the legacy model scores or other model outputs.

For example, with transactions in a transaction data set, the type of operation point may be “percentage of total population” on which to act if their score meets or exceeds the score threshold of that operation, such as a lower boundary or cutoff (e.g., where a higher score indicates a higher correlation to the analyzed data for pattern recognition, such as a higher likelihood of fraud when performing risk and/or fraud analysis and detection based on one or more fraud patterns in the transaction data set). Different operation points may be set, such as 0.3% of the population to identify, in a progressively higher and/or lower manner over a desired range of operation points for the data set, which may cause records to be identified or flagged. Operation point values between a high and low operation point may also have a higher cutoff before the scores fall into the scoring range for a next, more restrictive operation point, indicating a higher correlation to or affinity for the analyzed pattern. Operation points 312 represented along the x-axis may be used for bucketing scores 314 according to their scoring range and distribution for model alignment along the y-axis.

As such, each operation point may have a range of scores and/or score values for model scores. Buckets may be created and/or assigned to different operation points (e.g., each operation point and the corresponding score range having a bucket, and the bucket may include a set of scores corresponding to the output model scores in that score range for the ML model at stake. For example, a bucket in legacy score bucket graph 304 may correspond to a first set of scores or other model outputs that were output by the legacy ML model and may be used to align the new ML model. As such, that bucket in legacy score bucket graph 304 may have a corresponding bucket with a second set of scores in new score bucket graph 302, which may be used to align model scores as discussed herein. Thus, the first set of data buckets in legacy score bucket graph 304 may be matched to corresponding ones of the second set of data buckets in new score bucket graph 302.

With new score bucket graph 302 and legacy score bucket graph 304, the new (e.g., to be deployed) ML model and the legacy (e.g., existing, old, or to be retired/update/brought offline) may be run on the same data set, or a data set have sufficient data records in common to allow for correlations between data records for the operation points, distributions, and the like. As such, new score bucket graph 302 and legacy score bucket graph 304 may include the same or similar scores and ranges of scores for the model task performed that may be bucketed by operation points 312 for each model's output scores. In new score bucket graph 302 and legacy score bucket graph 304, as the values for operation points 312 along the x-axis increases (e.g., the percentage of the population on which to take action based on the models'scores), it is seen that the values for scores 314 along the y-axis significantly decreases, indicating a lower score value and therefore threshold is required for taking action against that now larger percentage of the population.

A mapping table may be generated to correlate and align model scores according to this curve or other pattern in the model parameters. A mapping table may consist of any number of rows, wherein in one example, this table may include 10,000 rows, where each row corresponds to an operation point and each row has four columns of data, a lower score cutoff, an upper score cutoff for the original score, a lower score cutoff for the target score, and an upper score cutoff for the target score, which may be determined based on the data records falling into a range of values (e.g., 700-800 for one model, while 550-600 for another model). The original scores may correspond to legacy score bucket graph 304, while the target scores may correspond to new score bucket graph 302, although other naming conventions may be used to identify the lower and upper score cutoffs for the range of values of scores 314 in each of operation points 312. Once the buckets have been created and/or have scores 314 assigned for each of operation points 312 per ML model to be aligned, the score ranges for each distribution point may be determined for each ML model. This provides an approximate score range conversion between the two ML models by enabling a system to determine, for a score falling into a certain range and distribution point, the range of similar scores for the same distribution point by when processed by another model.

However, there may be small differences between scores 314 in a particular range for one or more of operation points 312. For example, individual distributions of scores 314 in the range of each of operation points 312 may vary. While the score-operation point relationship within one bucket may be treated as a linear relationship, in the mapping table, the distribution of scores 314 may be transformed from the original (e.g., new or to be deployed) model's distribution to the target (e.g., the old, retired, or previous version prior to updating/replacing) model's distribution and the desired target score for processing by one or more downstream processors including other ML models, rules, services, and the like. When transforming between distributions, scores may be ranked based on where they fall in a range of values. Once ranked, scores 314 may be converted by determining the same rank in the distribution and rank of scores for the other model's scores, or the target scores range and/or distribution. As such, scores having different ranges or distributions between different model outputs may be converted for processing by other, downstream processors.

For example, where a new score value is 600 and the score range for an operation point is 550-650, the score would be ranked as 50%. This may be computed for each model and the scores in the model's operation point range using the following score ranking formula: (Model Score−Lower Boundary Cutoff)/(Upper Boundary Cutoff−Lower Boundary Cutoff)=Model Score Rank. The score value therefore for the target score rank may be calculated using the following formula: (Model Score Rank*(Upper Boundary Cutoff−Lower Boundary Cutoff))+Lower Boundary Cutoff=Model Score. For a new score value of 600 and an operation point range of 550-650 for a new ML model, the target score value for the legacy ML model that has the same operation point range of 800-900 would be 850. As such, 850 would be fed to a downstream processor of the new model's output in place of the new model's score of 650, or the downstream processor may compute the converted score value of 850 after receiving the output of the new ML model and mapping file or data necessary for mapping the conversion and scores/score ranges mapped between the two models.

At a later time, when a different computing service requests ML decisioning and/or processing of data using the latest version of the ML model, the mapping may be utilized to convert between the scores and align the new model's scores to that of the old model. This may be true for all services that may deploy and utilize the model, as well as all downstream models, rules, and/or services that are dependent on outputs from the ML model. Conventionally, testing and deployment would require independent tests of the change to the downstream or dependent components, and a determination and/or retraining, reconfiguring, or adjusting each of those components to process the new model's scores correctly. In contrast, the present system allows for immediate deployment of ML models and/or other AI models, rules, and the like in a fast and efficient manner, with minimal impact on other systems and reduced workload from testing and reconfiguring downstream and/or dependent AI components for use of the new model's scores.

In diagram 300b of FIG. 3B, components and operations for a “hot swap” of ML models is performed through the use of a data package having a configured mapping file, table, or other data that enables score alignments to be performed between the models. This enables immediate use of the new model when swapped in without requiring reconfiguring and/or retraining of any downstream processors, ML models, rules, and/or services for processing of the new model's scores, score ranges, thresholds for operation points or other threshold on which an action is taken, and the like. A model “hot swap” may generally refer to the practice of adding and removing components of a computer system while the power remains on, and therefore may correspond to a practice where the ML decisioning pipeline, engine, and/or system is not required to be taken offline or brought down to be patched, and instead a model may be inserted into the place of an existing and to be retired or otherwise changed and removed model. A hot swap of models for AI purposes may correspond to a similar practice where models may be swapped in or out for ML model scoring and other ML outputs without significant effects on other components of the ML system, such as by requiring the ML system to go offline for other model reconfigurations, testing, training, or the like. A hot swap is therefore preferrable as it enables the ML pipeline or other system to continue functioning and providing AI services while being updated with better, more advanced, more accurate, or trained on the latest data for pattern recognition and intelligent outputs.

In diagram 300b, for a legacy model 322, a hot swap 324 being performed using model package 326 may refer to replacing legacy model 322 in the ML pipeline or other ML engine or system without affecting other components and/or without having to take the ML pipeline offline. This may include injecting calls to a processor for a new model 328 for model package 326 to the ML pipeline, routing traffic to that processor, or otherwise utilizing model package 326 to execute new model 328 for model scoring or other model outputs in place of legacy model 322. Legacy model 322 may then be retired, taken offline, deleted, removed from the ML pipeline (but can be retained for other outputs, such as those that may be required by other ML tasks, pipelines, or systems of ML models), or otherwise changed and replaced. Hot swap 324 of model package 326 while taking out legacy model 322 therefore inserts, places, and/or deploys new model 328 into the ML pipeline and/or production system for ML outputs, where legacy model 322 is no longer used. Legacy model 322 may previously have been used to provide outputs to downstream models 206, where new model 328 may similarly be required to operate on the same or similar data and provide ML model scores for processing by downstream models 206. Downstream models 206 may further be connected to rules 208, and therefore an inaccuracy or inconsistency in model scores and inferences upstream may have a significant effect on the downstream models, rules, services, and/or other processors, which can lead to inaccurate predictions or outputs.

Conventionally, hot swap 324 was either not possible due to the significant model effects of a new ML model on an ML model pipeline that relies on specific data values to draw inferences from pattern recognition, or, if performed, would lead to inaccuracies with downstream services that relied on the previous model's scores, ranges, and operation points. As such, hot swap 324 would not be performed and a full ML pipeline update may be required. However, as discussed herein, model package 326 may include a mapping table 330 or other mapping file and/or data that maps score ranges from a higher cutoff to a lower cutoff for operation points of the model scores. The model scores may be output by each model for processing and/or scoring (e.g., using a trained ML function algorithm, or the like) a test data set or other data set using model score alignment. Mapping table 330 may include multiple rows, each corresponding to an operation point having a range of model scores for both ML models for that operation point before being considered a model score in another higher or lower operation point.

The columns of mapping table 330 may identify the upper and lower cutoff scores for each model tested, such as the new model and the legacy model. In some embodiments, mapping table 330 may include additional columns (e.g., each by pairs of two for upper and lower boundaries or cutoff points for each operation point) that may correspond to any additional ML models where conversion between the three or more models may be desirable. Thus, when hot swap 324 is performed, model package 326 is deployed in place of legacy model 322 with mapping table 330 so that scores output by new model 328 can be transformed or converted into scores that would be output by legacy model 322. However, because new model 328 may be trained on emerging trends or may have other benefits over legacy model 322 based on available training data, advancements in ML, and the like, new model 328 may retain its applicability and benefit while benefitting from hot swap 324 to prevent significant system overhaul and updating, and being able to efficiently be deployed for immediate and accurate ML outputs.

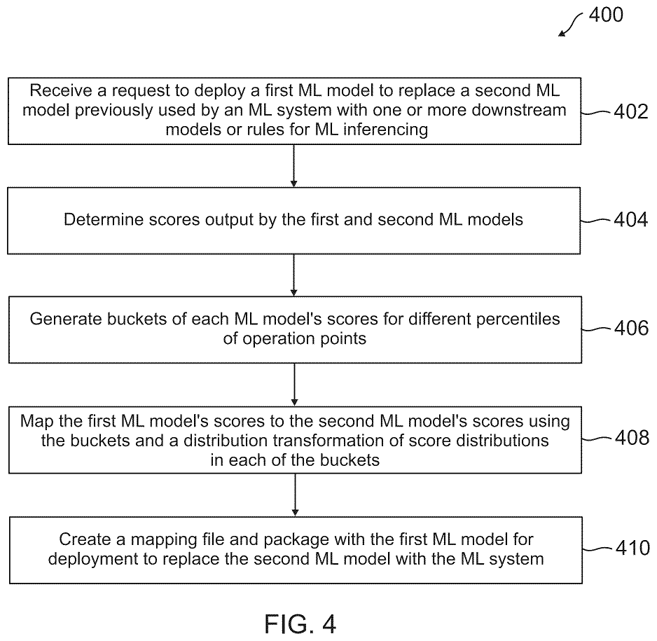

FIG. 4 is a flowchart 400 of an exemplary process for automatic alignment of machine learning model scores for model deployments having compatibility with downstream computing services, according to an embodiment. Note that one or more steps, processes, and methods described herein of flowchart 400 may be omitted, performed in a different sequence, or combined as desired or appropriate.

At step 402 of flowchart 400, a request is received to deploy a first ML model to replace a second ML model previously used by an ML system with one or more downstream models or rules for ML inferencing. The request may be a direct request or an indirect request that may indicate a need to replace the second ML model, such as when the second ML model is determined to be outdated or a newer version of the ML model is available. ML models and other AI systems may continuously be monitored for accuracy of outputs and relevancy, as the AI components may only be as accurate and capable of handling emerging threats as trained and/or configured. However, with the speed at which threats emerge and fraudsters find new means to compromise security systems, AI components may require frequent updates and/or new model deployments. For example, with service applications 122, ML models 124 may include those trained for risk and fraud but may not have been trained on a new emerging pattern of fraudulent behavior that previously had not been seen. As such, where one of ML models 124 requires updating, such as a swap, exchange, or replacement of a legacy version of a model to a new version of that model, MDA platform 130 may assist with aligning scores 132 so that ML system 123, and downstream processors as well as requesters of computing services such as merchants and customers for transactions, may experience little to no changes, downgrades, or declines in inferencing speed, accuracy, and/or other metric of good AI functionality. The data processing requests may be uploaded and/or provided by one or more coders, users, administrators, or the like to a data repository and/or test service that tests and/or deploys the data processing requests that may be associated with one or more common assets shared between the decision services. Instead, MDA platform 130 may identify the new model designated for deployment and may create a mapping of the new model's scores to the legacy model's scores for a data package used to deploy the new model.

At step 404, scores output by the first and second ML models are determined. A data set for score alignment determination and mapping file or table creation is determined, which may correspond to a data set of data records relevant to the model's inferencing or other ML purposes. For example, with risk models for transaction processing, a transaction data set may be determined. The data set may include a sufficient number of data records or other points that operation points may be determined for percentages of the data records population or set on which an action would be taken based on the score. For example, if an action is only to be taken on transaction having the highest 0.3% of transactions score in the transaction data set, then a high operation point may result. The data set may be run by both models and scores may be determined, which may be associated with corresponding data records and therefore allow for operation points to be determined as may be desired for the particular models and scoring alignment requirements (e.g., more operation points may result in smaller ranges with less data records and therefore potentially more accuracy with score conversions, but may be larger and more resource intensive to compute the mappings and utilize those mappings during real-time ML scoring and outputs).

At step 406, buckets of each ML model's scores for different percentiles of operation points are generated. Buckets may correspond to groups or selections of the data records and may be correlated to an operation point. Each bucket may have a range of scores from a lower boundary or cutoff to a higher boundary of cutoff, and may have a distribution of those scores over that range. As such, a number of buckets are generated depending on the computed or desired number of operation points, and the buckets may be used to correlate a subset of the scores with a particular operation point, score range, score boundaries for that operation point, and the like.

At step 408, the first ML model's scores are mapped to the second ML model's scores using the buckets and a distribution transformation of score distributions in each of the buckets. Mapping may be performed between scores 314 using distribution points 312 and a linear relationship and/or formula for a score conversion process based on score rank between the range of values for each operation point. In this regard, scores 314 may be mapped be correlating the score ranges for the same operation point between the new and legacy models. Mapping table 330 may be computed as a result, which may identify each operation point and its higher and lower score cutoff or boundary for the operation point in each model's output scores, and conversion between model scores may be performed using the score ranking formula discussed herein with regard to FIG. 3A.

At step 410, a mapping file and package with the first ML model is created for deployment to replace the second ML model with the ML system. A module, tool, application, or the like for an ML model deployer of MDA platform 130 may generate a data file for the mapping information and/or table, and may package the mapping file with model assets, code, artifacts, and the like that may be used to deploy the ML model in a data package. The data package may correspond to a data file having the mapping file and the components, assets, and/or code necessary to run the new ML model, as well as any code necessary to utilize the mapping file for score conversions or transformation from the original score (i.e., the score of the new model) to the target score of the legacy ML model, such as a score that would have been output by the legacy ML model based on the same or similar data. The data package may be used in one or more ML model deployments or deployments for corresponding AI components. For example, hot swap 324 may swap model package 326 for new model 328 in place of legacy model 322 for data scoring, inferencing, and/or decision-making. The data package may also be made available to other systems and/or AI engines and processors, such as to update their ML model infrastructure by replacing the legacy model used in such infrastructure with the data package.

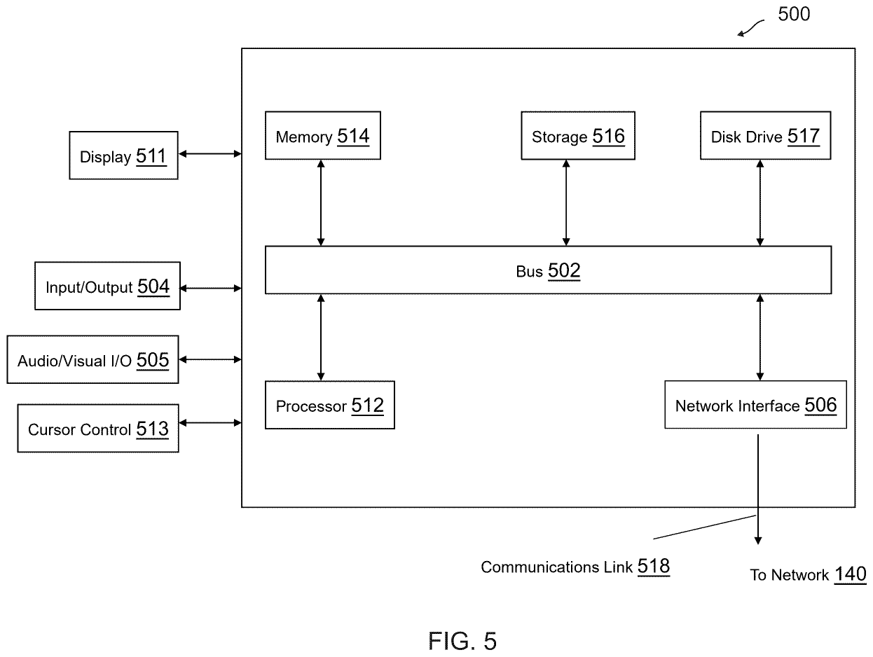

FIG. 5 is a block diagram of a computer system 500 suitable for implementing one or more components in FIG. 1, according to an embodiment. In various embodiments, the communication device may comprise a personal computing device e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, image, or links, and/or moving one or more images, etc., and sends a corresponding signal to bus 502. I/O component 504 may also include an output component, such as a display 511 and a cursor control 513 (such as a keyboard, keypad, mouse, etc.). An optional audio input/output component 505 may also be included to allow a user to use voice for inputting information by converting audio signals. Audio I/O component 505 may allow the user to hear audio. A transceiver or network interface 506 transmits and receives signals between computer system 500 and other devices, such as another communication device, service device, or a service provider server via network 140. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a non-transitory memory; and
one or more hardware processors coupled to the non-transitory memory and configured to execute instructions to cause the system to:
access, for a machine learning (ML) system having a plurality of ML models including at least one downstream ML model that utilizes first outputs of a first ML model, a second ML model that is to replace the first ML model in the ML system;
determine a first set of scores for the first ML model and a second set of scores for the second ML model;
generate a first set of data buckets for the first set of scores and a second set of data buckets for the second set of scores based on a plurality of threshold percentiles of model outputs by the first ML model and the second ML model;
create a mapping file of the first set of scores mapped to the second set of scores using the first and second set of data buckets and a distribution transformation of a score distribution in each of the first and second sets of data buckets; and
deploy the second ML model to replace the first ML model, within the ML system, with the mapping file that enables mapping second outputs of the second ML model to the first outputs for the at least one downstream ML model.

2. The system of claim 1, wherein the first and second sets of scores each comprise a plurality of model outputs based on data records processed by the first ML model or the second ML model, and wherein each bucket in the first and second sets of data buckets corresponds to one of the threshold percentiles of the data records identified by a corresponding one of the first ML model based on the first set of scores or the second ML model based on the second set of scores.

3. The system of claim 2, wherein each of the model outputs corresponds to an operation point for a percentage of a population of the data records for an action to be taken based on scoring by the first ML model and the second ML model.

4. The system of claim 1, wherein executing the instructions further causes the system to:
receive a request for an ML output by the ML system;
determine a second model score associated with the request using the second ML model; and
determine a predicted first model score for the second model score based on the mapping file, wherein the predicted first model score is determined using the distribution transformation for one of the first set of data buckets mapped to one of the second set of data buckets.

5. The system of claim 4, wherein executing the instructions further causes the system to:
process the predicted first model score using the at least one downstream model; and
determine the ML output based at least on processing the predicted first model score.

6. The system of claim 1, wherein executing the instructions further causes the system to:
monitor predicted first model scores determined from second model scores of the second ML model and the mapping file; and
determine whether the predicted first model scores cause ML outputs of the ML system to fail to meet a scoring threshold.

7. The system of claim 1, wherein the mapping file is packaged with the second ML model in a data package, and wherein the data package is utilized to deploy the second ML model with at least the ML system to replace the first ML model.

8. The system of claim 1, wherein the first ML model and the second ML model comprise upstream models in an ML pipeline comprising two or more of the plurality of ML models, and wherein the ML pipeline uses score alignments between each of the two or more of the plurality of ML models for ML outputs of the ML system.

9. The system of claim 1, wherein determining the first set of scores and the second set of scores is performed on a same data set processed by the first ML model and the second ML model, and wherein each data record in the same data set is mapped to a corresponding score in the first set of scores and the second set of scores, and wherein a distribution of the first set of scores in each of the first set of data buckets is transformed to a corresponding distribution of the second set of scores in each of the second set of data buckets for the distribution transformation.

10. The system of claim 9, wherein the same data set comprises a transaction data set and each data record corresponds to a transaction scored by the first ML model and the second ML based on a risk associated with the transaction.

11. A method comprising:
receiving a request for a machine learning (ML) output of an ML system using a first ML model, wherein the first ML model is to replace a second ML model previously used by the ML system with a downstream processor that processed second model scores output by the second ML model;
determining a first model score based on the request using the first ML model;
determining an alignment of the first model score to the second model scores based on a mapping of first model scores of the first ML model to the second model scores of the second ML model, wherein the mapping is based on a plurality of buckets for a plurality of operation points of the first ML model and the second ML model, and wherein the plurality of buckets map corresponding portions of the first model scores to the second model scores for the plurality of operation points using a distribution transformation;
mapping the first model score to a corresponding one of the second model scores associated with one of the plurality of buckets; and
providing the mapped first model score to the downstream processor.

12. The method of claim 11, wherein the downstream processor comprises a third ML model that utilizes the first model scores and the second model scores for a determination of third model scores, and wherein the plurality of operation points are associated with one or more thresholds used by the third ML model when processing the first model scores.

13. The method of claim 12, wherein the downstream processor comprises artificial intelligence (AI) engine configured to execute one of two or more actions based on the mapped first model score and a corresponding one of the one or more score thresholds.

14. The method of claim 11, wherein the mapping uses a mapping file or a configurable conversion process of an ML model package usable to convert the first model scores to the second model scores based on the alignment.

15. The method of claim 14, wherein mapping the first model score to a corresponding one of the second model scores includes generating or updating a mapping file with the mapped first model score or configuring a score conversion process of an ML model deployment package for the first ML model.

16. The method of claim 14, wherein the alignment utilizes distributions for the first model scores and the second model scores in each of the plurality of buckets for the distribution transformation.

17. The method of claim 11, wherein the mapping comprises information identifying the second model scores as being used with the second ML model that has been removed from the ML system, and wherein the information further identifies the first ML model as in current use by the ML system.

18. A non-transitory machine-readable medium having stored thereon machine-readable instructions executable to cause a machine to perform operations comprising:
determining that a first machine learning (ML) model is to be replaced by a second ML model with an ML pipeline having at least one additional component that processes an output of the first model when the ML pipeline is used to determine an action to take;
determining a plurality of first model scores for the first ML model and a plurality of second model scores for the second ML model using a data set having a plurality of records;
generating a first set of data buckets for the first set of scores and a second set of data buckets for the second set of scores based on a plurality of operation points for model decisions by the first ML model and the second ML model;
determining a mapping of the first set of scores to the second set of scores using the first and second set of data buckets and distributions of scores in the first and second sets of data buckets, wherein the mapping aligns model scores determined by the second ML model to the first ML model;
generating a data package including at least the second ML model and the mapping; and
deploying the data package to replace the first ML model in the ML pipeline.

19. The non-transitory machine-readable medium of claim 18, wherein each record in the plurality of records has a corresponding score in each of the plurality of first model scores and the plurality of second model scores, and wherein the mapping is determined based on aligning the corresponding score between the first ML model and the second ML model for each of the plurality of records and transforming the distributions of scores between corresponding ones of the first and second sets of data buckets.

20. The non-transitory machine-readable medium of claim 18, wherein the at least one additional component comprises a third ML model that uses, as an input, the output of the first model when the ML pipeline determines the action to take.
